(19) United States
(12) Patent Application Publication
(10) Pub. No.: US 2026/0006176 A1
(43) Pub. Date: Jan. 1, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Junru Li, Beijing (CN); Kai Zhang, Los Angeles, CA (US); Li Zhang, Los Angeles, CA (US)

(21) Appl. No.: 19/316,899

(22) Filed: Sep. 2, 2025

Related U.S. Application Data
(63) Continuation of application No. PCT/CN2024/079763, filed on Mar. 1, 2024.

(30) Foreign Application Priority Data
Mar. 2, 2023 (WO) PCT/CN2023/079422

(51) Int. Cl. H04N 19/105; H04N 19/159; H04N 19/176; H04N 19/70

(52) U.S. Cl. CPC H04N 19/105; H04N 19/159; H04N 19/176; H04N 19/70

(57) ABSTRACT

Embodiments of the disclosure provide a solution for video processing. A method for video processing is proposed. The method includes: applying, for a conversion between a video unit of a video and a bitstream of the video, a process to the video unit based on coding information of a non-adjacent neighbor video unit; and performing the conversion based on the processed video unit.

### CROSS REFERENCE

This application is a continuation of International Application No. PCT/CN2024/079763, filed on Mar. 1, 2024, which claims the benefit of International Application No. PCT/CN2023/079422, filed on Mar. 2, 2023. The entire contents of these applications are hereby incorporated by reference in their entireties.

### FIELDS

Embodiments of the present disclosure relates generally to video processing techniques, and more particularly, to intra mode coding based on coding information of non-adjacent neighbors.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a video unit of a video and a bitstream of the video, a process to the video unit based on coding information of a non-adjacent neighbor video unit; and performing the conversion based on the processed video unit.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying a process to a video unit of the video based on coding information of a non-adjacent neighbor video unit; and generating the bitstream based on the processed video unit.

In a fifth aspect, a method for storing a bitstream of a video is proposed. The method comprises: applying a process to a video unit of the video based on coding information of a non-adjacent neighbor video unit; generating the bitstream based on the processed video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an illustration of the effect of the slope adjustment parameter “u”. Left: model created with the current CCLM. Right: model updated as proposed;

FIG. 5 shows neighboring blocks (L, A, BL, AR, AL) used in the derivation of a general MPM list;

FIG. 6 shows neighboring reconstructed samples used for DIMD chroma mode;

FIG. 7 shows intra template matching search area used;

FIG. 8 shows use of IntraTMP block vector for IBC block;

FIG. 9 shows the division method for angular modes;

FIG. 10 shows extended MRL candidate list;

FIG. 11 is an illustration of the template area;

FIG. 12 shows spatial part of the convolution filter;

FIG. 13 shows reference area (with its paddings) used to derive the filter coefficients;

FIG. 14 shows four Sobel based gradient patterns for GLM;

FIG. 15 shows spatial GPM candidates;

FIG. 16 shows GPM template;

FIG. 17 shows GPM blending;

FIG. 18 is an illustration of locations of non-adjacent merge candidates and the current video unit;

FIG. 19 illustrates a flowchart of a method for video processing in accordance with embodiments of the present disclosure; and

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment.” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

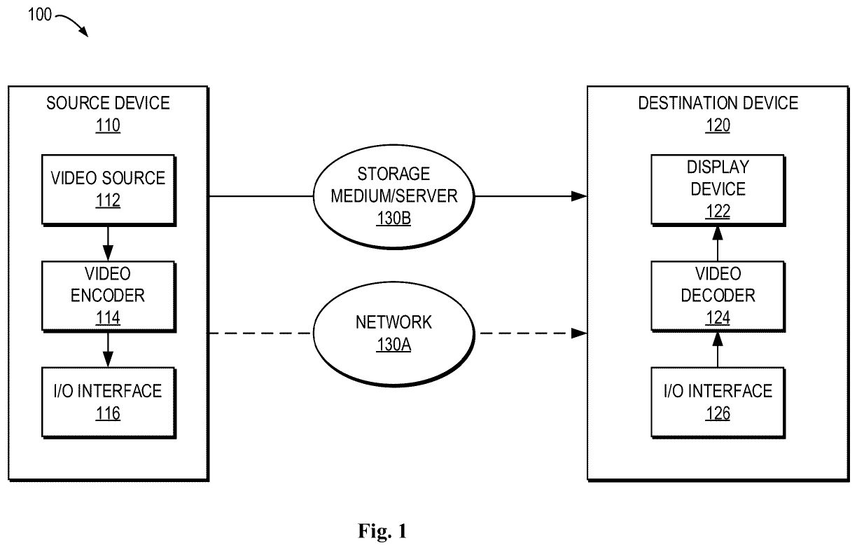

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

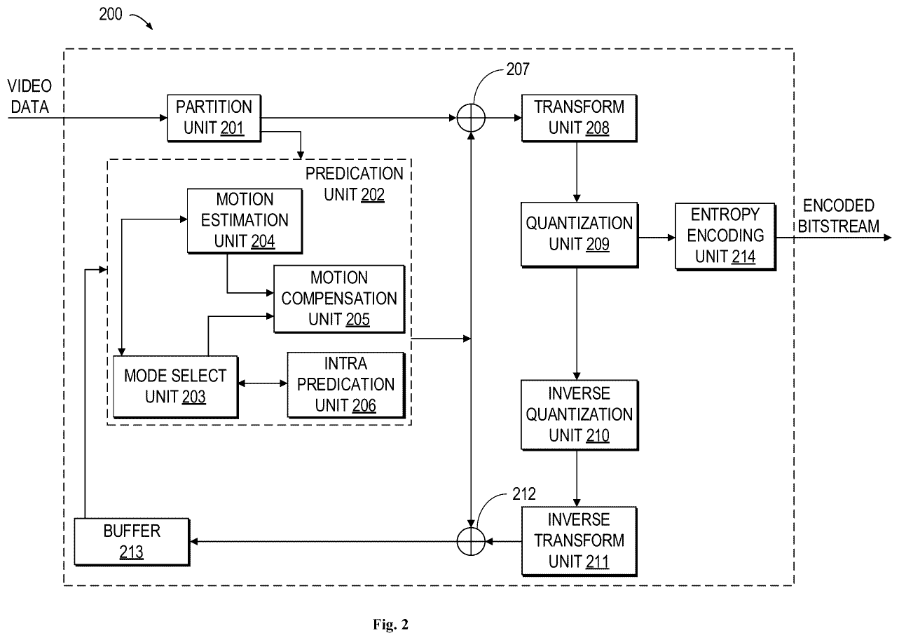

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

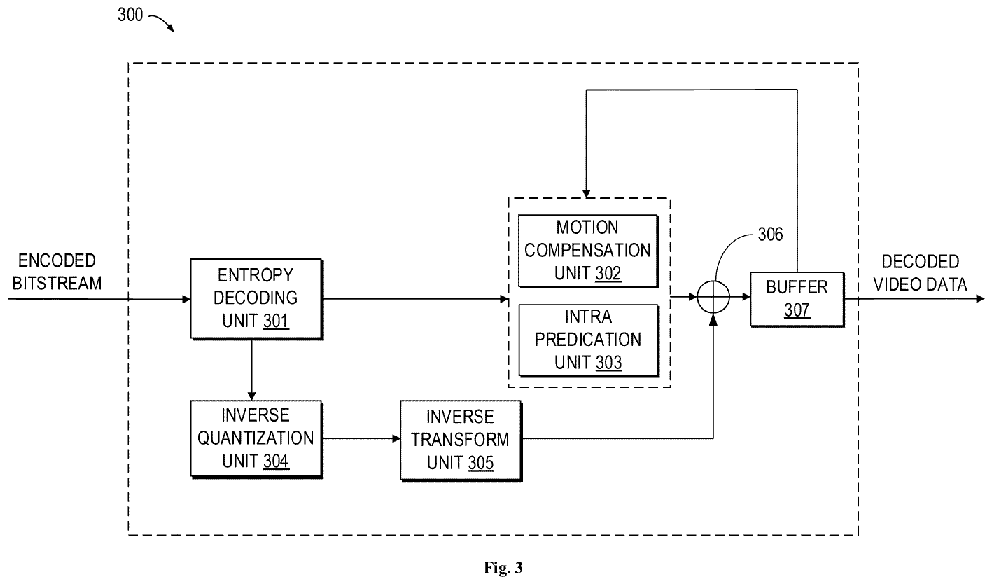

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is about intra prediction in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes (JVET-D0110). In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chroma Val = a * luma Val + b$$

An adjustment “u” to the slope parameter is signaled to update the model to the following form:

$$chroma Val = a ’ * lumaVal + b ’$$

$$where$$

$$\begin{matrix}a ’ = a + u \\ b ’ = b - u * {y}_{r} .\end{matrix}$$

With this selection the mapping function is tilted or rotated around the point with luminance value yᵣ. The average of the reference luma samples used in the model creation as yᵣ in order to provide a meaningful modification to the model. Picture below illustrates the process.

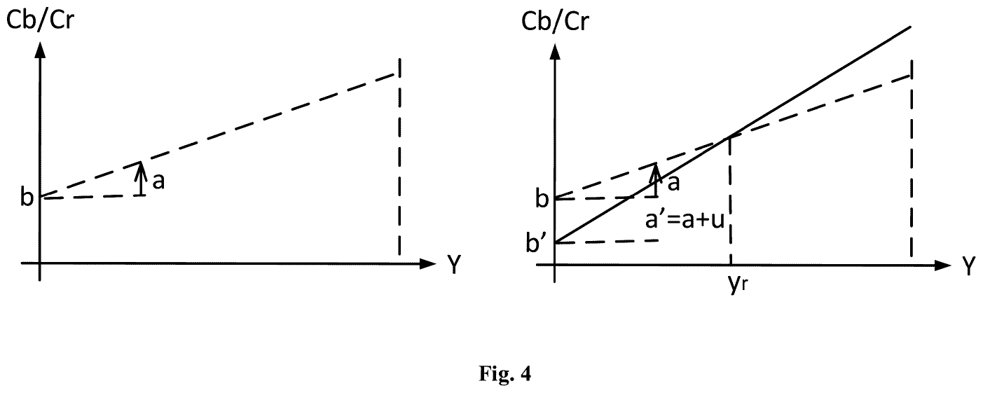

FIG. 4 is an illustration of the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied (JVET-Q0391). The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced as described in JVET-D0114. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

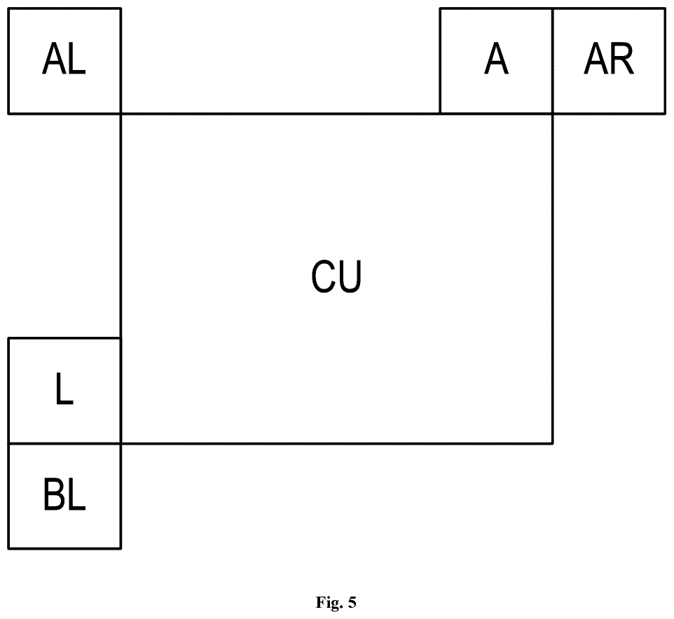

FIG. 5 shows neighbouring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, as described in JVET-D0119, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients as described in JVET-00449. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$\begin{matrix}x = Floor ( Log 2 ( Gx ) ) \\ normDiff = ( ( Gx ≪ 4 ) ≫ x ) \& 15 \\ x += ( 3 + ( normDiff != 0 ) ? 1 : 0 ) \\ Orient = ( Gy * ( DivSig Table [ normDiff ] \vert 8 ) + ( 1 ≪ ( x - 1 ) ) ) ≫ x\end{matrix}$$

$$where$$

$$DFivSig Table [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

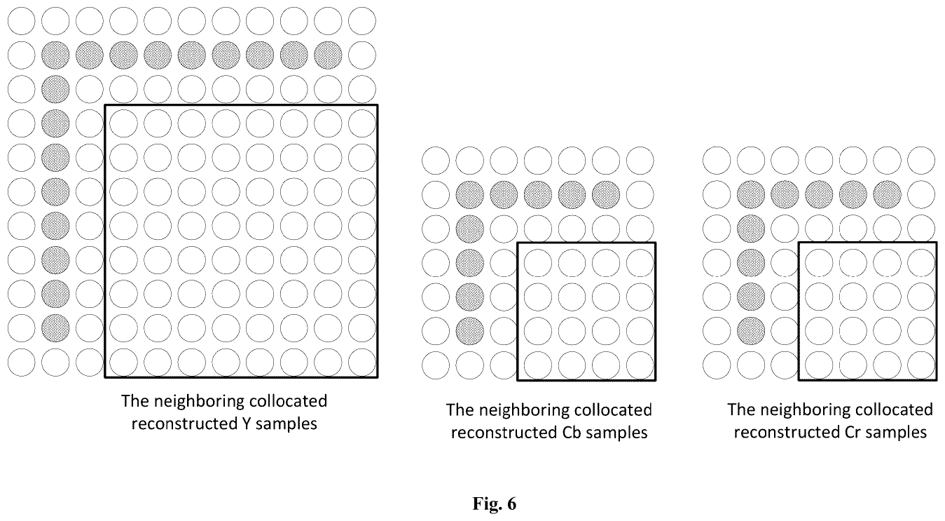

FIG. 6 shows neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. This method only applies to I slices.

### 2.1.7 Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

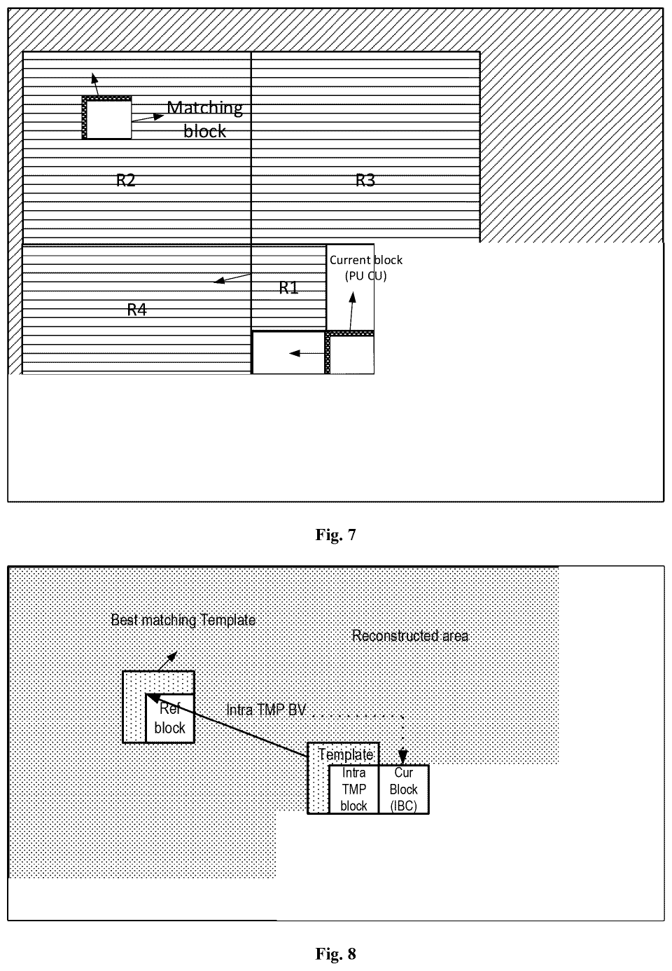

The prediction signal is generated by matching the L-shaped causal neighbor of the current block with another block in a predefined search area in FIG. 7 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW \\ SearchRange\_h = a * BlkH\end{matrix}$$

Where ‘a’ is a constant that controls the gain/complexity trade-off. In practice, ‘a’ is equal to 5.

FIG. 7 shows Intra template matching search area used.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

IntraTMP block vector is stored in the IBC block vector buffer and, the current IBC block can use both IBC BV and IntraTMP BV of neighbouring blocks as BV candidate for IBC BV candidate list as shown in FIG. 8. FIG. 8 shows use of IntraTMP block vector for IBC block.

IntraTMP block vectors are added to IBC block vector candidate list as spatial candidates.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * cos Model .$$

If this condition is true, the fusion is applied, otherwise the only mode1 is used.

Weights of the modes are computed from their SATD costs as follows:

$$\begin{matrix}weight 1 = costMode 2 / ( cost Mode 1 + costMode 2 ) \\ weight 2 = 1 - weight 1\end{matrix}$$

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
1) For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
2) For TIMD mode with blending, pₗᵢₙₑ is used for the first mode (w₀=1, w₁=0) and pₗᵢₙₑ₊₁ is used for the second mode (w₀=0, w₁=1).
3) For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index<34), the current block is vertically divided; for near-vertical modes (34<=angular mode index<=66), the current block is horizontally divided.

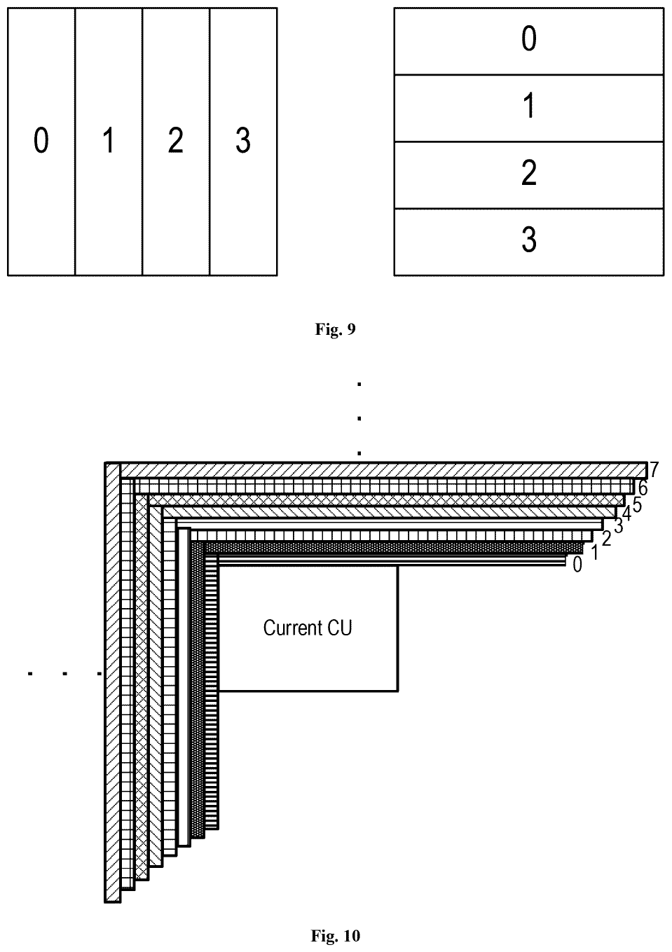

The (wIntra, wInter) for different sub-blocks are shown in FIG. 9. FIG. 9 shows the division method for angular modes.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used. FIG. 10 shows extended MRL candidate list.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added.

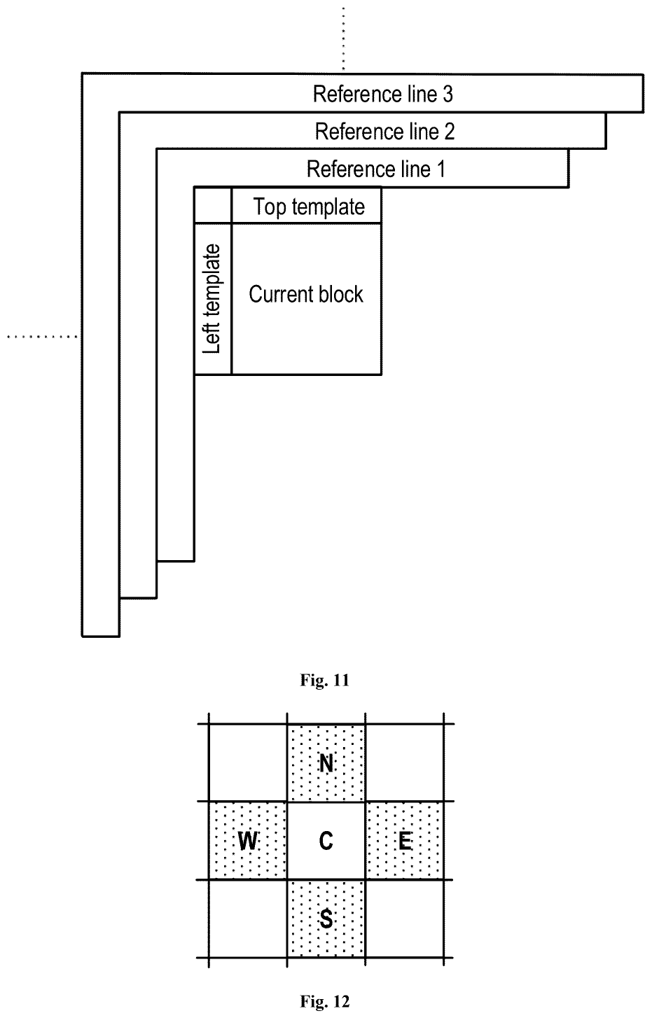

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list. FIG. 11 is an illustration of the template area.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated below. FIG. 12 shows spatial part of the convolutional filter.

The nonlinear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$pred Chroma Val = {c}_{0} C + {c}_{1} N + {c}_{2} S + {c}_{3} E + {c}_{4} W + {c}_{5} P + {c}_{6} B$$

### 2.1.13.2 Calculation of Filter Coefficients

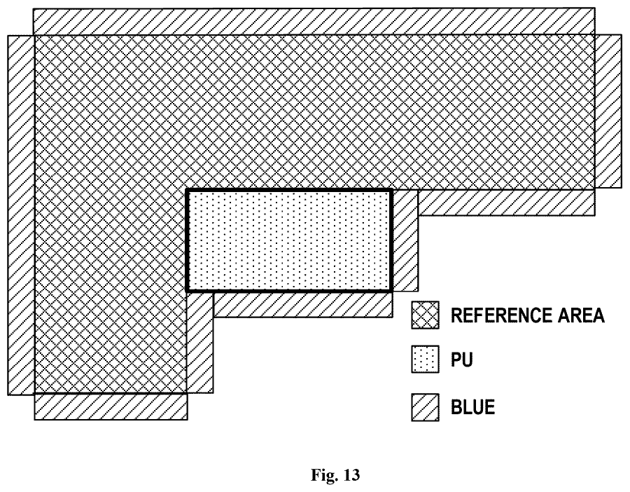

The filter coefficients cᵢ are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas. FIG. 13 shows reference area (with its paddings) used to derive the filter coefficients.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}{C}^{′} = C - offse tLuma \\ {N}^{′} = N - offset Luma \\ {S}^{′} = S - offset Luma \\ {E}^{′} = E - offset Luma \\ {W}^{′} = W - offset Luma \\ {P}^{′} = nonLinear \\ B = mid Valu e = 1 ≪ ( bitDepth - 1 )\end{matrix}$$

and the chroma value is predicted using the following equation, where offsetChroma is equal to offsetCr and offsetCb for Cr and Cb components, respectively:

$$pred Chroma Val = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2. 1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

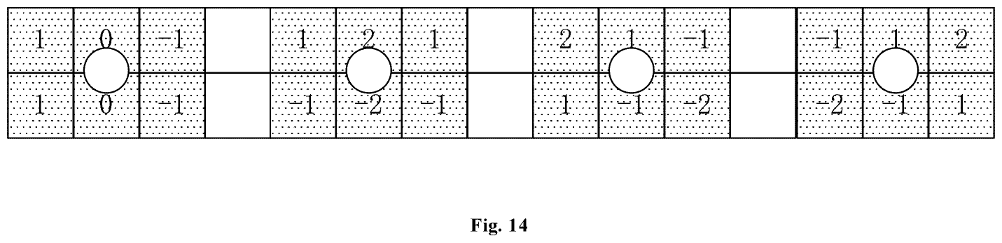

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14.

FIG. 14 shows four Sobel based gradient patterns for GLM.

### 2.1.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

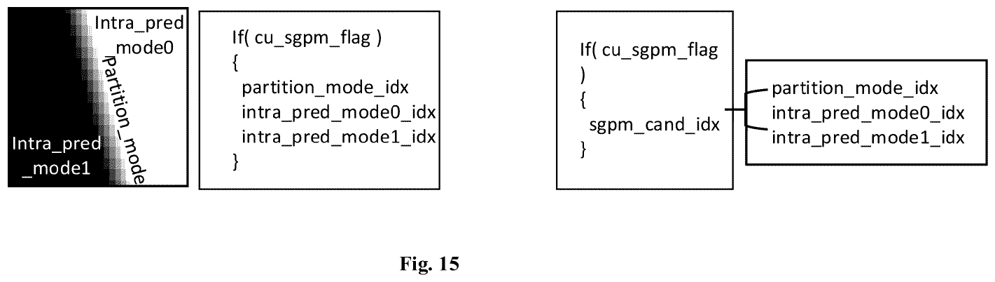

SGPM is an intra mode that resembles the inter coding tool of GPM, where the two prediction parts are generated from intra predicted process. In this mode, a candidate list is built with each entry containing one partition split and two intra prediction modes as shown in FIG. 15. 26 partition modes and 3 of intra prediction modes are used to form the combinations, the length of the candidate list is set equal to 16. The selected candidate index is signalled.

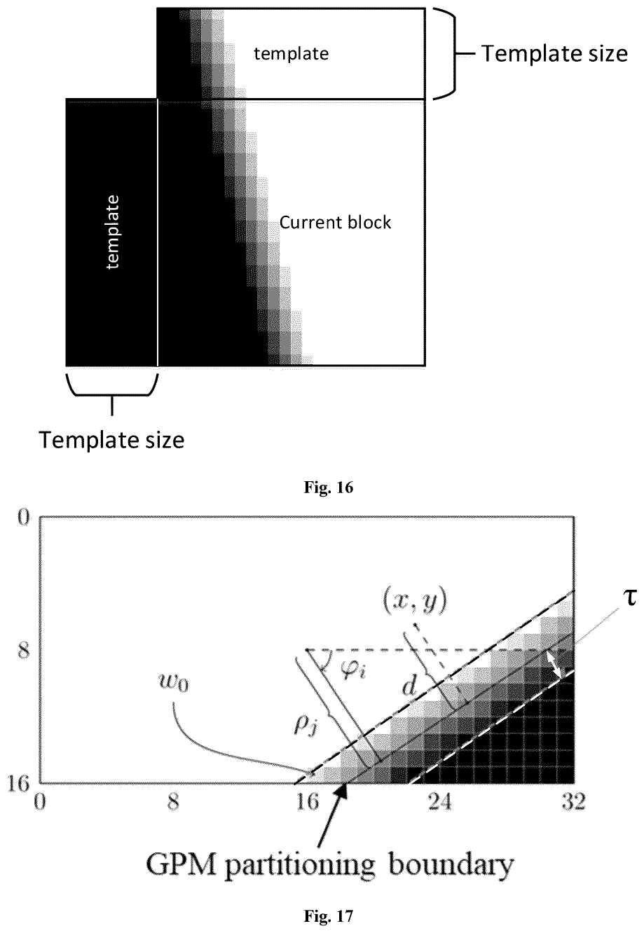

FIG. 15 shows spatial GPM candidates. FIG. 16 shows GPM template. FIG. 17 shows GPM blending.

The list is reordered using template (FIG. 16) where SAD between the prediction and reconstruction of the template is used for ordering. The template size is fixed to I.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

Adaptive blending is also used for spatial GPM, where blending depth τ shown in FIG. 17 is derived as follows:
If min(width, height)==4, ½ τ is selected
else if min(width, height)==8, τ is selected
else if min(width, height)==16, 2 τ is selected
else if min(width, height)==32, 4 τ is selected
else, 8 τ is selected

### 3. Problems

There are several issues in the existing video coding techniques, which would be further improved for higher coding gain.
1. In ECM (e.g., up to ECM-8.0), different MPM lists are built for different coding tools to derive an intra mode for intra luma coding. However, coding information of non-adjacent intra coded blocks are not used for current intra block's coding. It may be redesigned for higher coding efficiency.

### 4. Detailed Solutions

The detailed embodiments below should be considered as examples to explain general concepts. These embodiments should not be interpreted in a narrow way. Furthermore, these embodiments can be combined in any manner.

The terms ‘video unit’ or ‘coding unit’ may refer to the colour component/sub-picture/slice/tile/coding tree unit (CTU)/CTU row/group of CTUs/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.

The terms ‘block’ may represent a CTB, a CTU, a CB, a CU, a PU, a TU, a PB, a TB, a subblock of a block, a sub-region within a block, any other region that contains more than one sample or pixel, etc.

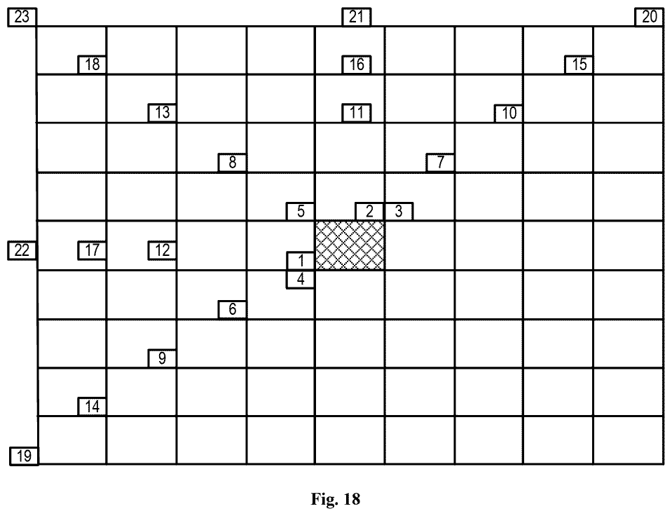

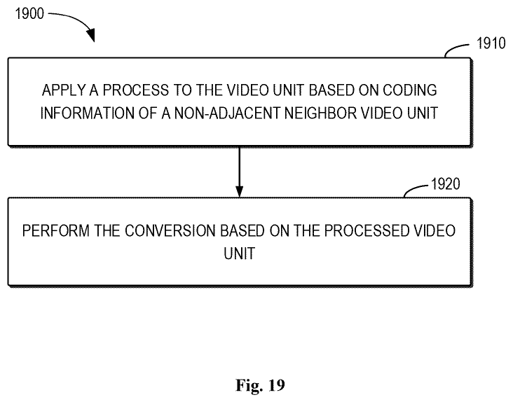

It is noted that the terminologies mentioned below are not limited to the specific ones defined in existing standards. Any variance of the coding tool is also applicable.
4.1 Coding information of a non-adjacent neighbor may be used for current block's coding.
   a. Intra mode coding information of a non-adjacent neighbor may be used for current block's intra/IBC/inter mode coding.
      1) For example, the intra mode coding information may refer to an intra mode index (e.g., DC, Planar, angular mode index, wide angle index, MIP mode index, etc.).
      2) For example, the intra mode coding information may refer to an intra tool used/enabled/on-off flag (e.g., intraTMP flag, MIP flag, ISP flag, TIMD flag, DIMD flag, MPM flag, etc.).
   b. IBC mode coding information of a non-adjacent neighbor may be used for current block's intra/IBC/inter mode coding.
      1) For example, the IBC mode coding information may refer to a block vector, etc.
   c. Inter mode coding information of a non-adjacent neighbor may be used for current block's intra/IBC/inter mode coding.
      1) For example, the IBC mode coding information may refer to motion vectors, block vectors, reference index, inter prediction direction, etc.
   d. The non-adjacent neighbor may be a coding unit in the current picture/subpicture/tile/slice/CTU row/CTU/VPDU.
   e. The non-adjacent neighbor may be a coding unit in a reference picture/subpicture/tile/slice/CTU row/CTU/VPDU.
   f. The positions of non-adjacent neighbors (e.g., for coding information storage and/or for coding information fetch/derivation) may be restricted according to a rule.
      1) It may be restricted to current CTU row and/or collocated CTU row in a reference picture.
      2) It may be restricted to current VPDU and/or collocated VPDU in a reference picture.
      3) It may be restricted to current tile and/or collocated tile in a reference picture.
      4) It may be restricted to current slice and/or collocated slice in a reference picture.
      5) It may be restricted to current subpicture and/or collocated subpicture in a reference picture.
      6) It may be restricted to current picture and/or reference pictures.
      7) It may be restricted to not exceed a decoded region of left M1 CTUs/VPDUs and/or above M2 CTUs/VPDUs and/or right M3 CTUs/VPDUs.
         i. For example, M1 and/or M2 and/or M3 are constant.
         ii. For example, M1 and/or M2 and/or M3 are variable dependent on block width and/or height.
      8) It may be restricted to not exceed a decoded region of a*cuWidth+b*cuHeight.
         i. For example, a and/or b are constant.
         ii. For example, a and/or b are variable dependent on block width and/or height.
      9) The non-adjacent neighbor may be a video unit coded prior to the current video unit.
   g. Whether the block is a non-adjacent neighbor of current coding unit may be dependent on the position (x0, y0) of the block and the position (x1, y1) of current coding unit.
      1) For example, the block may be a previous coded coding unit.
      2) For example, x0 is NOT equal to x1 and/or y0 is NOT equal to y1.
         a) For example, x0!=x1 and/or y0!=y1.
      3) For example, absolute value of y0−y1 is larger than or no less than b and/or absolute value of x0−x1 is larger than or no less than a.
         a) For example, abs(x0−x1)>a and/or abs(y0−y1)>b.
         b) For example, abs(x0−x1)>=a and/or abs(y0-y1)>=b. For example, a may be equal to a value from {0, 1, 2, 3, 4, 5, 6, 7, 8, 16, 24, 32}.
         c) For example, b may be equal to a value from {0, 1, 2, 3, 4, 5, 6, 7, 8, 16, 24, 32}.
      4) For example, the position is the center of the block.
      5) For example, the position is the left/right and top/bottom corner of the block.
   h. Whether the proposed method is used at a video unit level may be based on pre-defined rules, without signalling.
      1) Alternatively, it may be based on syntax element.
   i. For example, non-adjacent neighbors may be checked after at least one neighbor block when it is used to predict the current block.
4.2 Coding information (e.g., intra modes) of a non-adjacent neighbor may be used for current block's intra prediction mode (IPM) or most probable mode (MPM) list generation.
   a. For example, it may be used for regular intra MPM list generation.
   b. For example, it may be used for TIMD MPM/IPM list generation.
   c. For example, it may be used for SGPM MPM/IPM list generation.
   d. For example, it may be used for GPM inter-intra MPM/IPM list generation.
   e. For example, it may be used for TMRL MPM/IPM list generation.
   f. For example, it may be used for IBC fusion (e.g., IBC-CIIP) MPM/IPM list generation.
   g. For example, it may be used for geometrical IBC (e.g., IBC-GPM) MPM/IPM list generation.
   h. For example, the mode candidates derived from non-adjacent neighbor may be put after those mode candidates derived from adjacent neighbor (such as left or above neighbor closes to the current video unit).
   i. For example, the mode candidates derived from non-adjacent neighbor may be put after TIMD/DIMD candidate.
   j. For example, the MPM/IPM list may be primary and/or secondary MPM/IPM list.
4.3 Coding information (e.g., intra modes) of a non-adjacent neighbor may be stored/derived based on a local buffer (or named as a “history-based table”).
   a. For example, the local buffer may be represented by a look-up-table.
      1) For example, the local buffer may be represented by a history-based look-up-table.
   b. For example, a or multiple local buffer may be maintained during the coding process of current picture/subpicture/tile/tile group/CTU/CTU row, and the elements in the buffer may be updated on-the-fly.
      1) For example, the elements in the look-up-table may be updated along with the encoding/decoding of a video unit in the current picture/subpicture/tile/tile group/CTU/CTU row, and then used for the coding of a future video unit in the current picture/subpicture/tile/tile group/CTU/CTU row/VPDU.
      2) For example, the table length/size may be equal to L.
         i. For example, L is pre-defined and equal to a constant.
         ii. For example, L is a variable based on sequence resolution and/or block dimensions, etc.
   c. For example, the local buffer may contain coding information of adjacent neighbors and/or non-adjacent neighbors.
      1) For example, the local buffer may contain coding information of both adjacent neighbors and non-adjacent neighbors.
      2) For example, the local buffer may only contain coding information of non-adjacent neighbors.
      3) For example, the local buffer may only contain coding information of adjacent neighbors.
   d. For example, the coding information of an intra/IBC/inter mode coded video unit may be stored in the local buffer.
      1) For example, the local buffer may be used for future block's intra/IBC/inter mode coding.
      2) For example, the coding information of an intra/IBC/inter mode coded video unit may be stored in multiple local buffers, separately.
         i. For example, the coding information of an intra mode coded video unit may be stored in a local buffer Lᵢₙₜᵣₐ.
         ii. For example, the coding information of an inter mode coded video unit may be stored in a local buffer Lᵢₙₜₑᵣ.
         iii. For example, the coding information of an IBC mode coded video unit may be stored in a local buffer L_{IBC}.
         iv. For example, the coding information of intra and/or IBC and/or inter mode coded video unit may be stored together in a local buffer Lₘᵢₓ.
   e. For example, construction/generation of the look-up-table may follow a first-in-first-out (FIFO) rule.
      1) For example, for an intra mode candidate to be inserted to the look-up-table, it may be inserted to the first order of the look-up-table (e.g., as the first element).
   f. For example, a pruning process (a.k.a., redundancy check) may be applied when inserting a new intra mode candidate to the look-up-table.
   g. For example, the pruning may be based on comparisons of the to-be-inserted candidate and all available elements in the look-up-table.
   h. For example, the pruning may be based on comparisons of the to-be-inserted candidate and M (e.g., M=1, or M=2, etc.) elements in the look-up-table.
      1) For example, the M elements may be at certain pre-defined orders in the look-up-table.
      2) For example, the M elements may refer to the first element of the look-up-table.
      3) For example, the M elements may refer to the first and second elements of the look-up-table.
   i. For example, the pruning may be based on intra mode index values and/or frequency of certain intra mode indexes.
      1) For example, only if there are enough (e.g., based on a threshold) coding units coded with a pre-defined intra mode index K, then the intra mode index K may be allowed to be inserted to the look-up-table.
   j. For example, intra mode coding for current video unit may be based on coding information stored in the local buffer (e.g., look-up-table).
4.4 Coding information (e.g., intra modes) of a non-adjacent neighbor may be stored/derived based on a picture/subpicture/tile/tile group/CTU/CTU row/VPDU wise buffer.
   a. For example, the coding information of video units in the current picture/subpicture/tile group/tile may be stored in the buffer.
      1) For example, the coding information in the buffer may be used for the coding of a future video unit in the current picture/subpicture/tile/tile group/CTU/CTU row/VPDU.
      2) For example, the coding information in the buffer may be used for the coding of a future video unit in a future picture/subpicture/tile/tile group/CTU/CTU row/VPDU.
   b. For example, intra mode coding for current video unit may be based on coding information stored in the picture/subpicture/tile group/tile/CTU/CTU row/VPDU wise buffer.
      1) For example, the positions of non-adjacent neighbors used for current intra mode coding may be predefined.
      2) For example, the positions may be aligned with non-adjacent inter merge candidates (e.g., as denoted in FIG. 18) in the current and/or reference picture.
      3) For example, the positions may be a subset of non-adjacent inter merge candidates (e.g., as denoted in FIG. 18) in the current and/or reference picture. FIG. 18. illustration of locations of non-adjacent merge candidates (denoted from 1 to 23) and the current video.
4.5 For example, the intra coding information may be stored in M×N granularity.
   i. For example, M=N=4.
   ii. For example, the int coding information of a specific block covered by or covering or overlapped with the M×N region may be stored to the M×N region.
      1) For example, the intra coding information of the first coded/decode block with intra information covered by or covering or overlapped with the M×N region may be stored.
      2) For example, the intra coding information of the last coded/decode block with intra information covered by or covering or overlapped with the M×N region may be stored.
      3) For example, the intra coding information of the coded/decode block with intra information covered by or covering or overlapped a specific position of the M×N region may be stored.
         a) The specific position may be the top-left/bottom-right/top-right/bottom-left/center position of the M×N region.
4.6 For example, the intra coding information may be stored in luma and chroma components separately.
4.7 A syntax element disclosed above may be binarized as a flag, a fixed length code, an EG(x) code, a unary code, a truncated unary code, a truncated binary code, etc. It can be signed or unsigned.
4.8 A syntax element disclosed above may be coded with at least one context model. Or it may be bypass coded.
4.9 A syntax element disclosed above may be signaled in a conditional way.

The SE is signaled only if the corresponding function is applicable.
4.10 A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
4.11 Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
4.12 Whether to and/or how to apply the disclosed methods above may be dependent on coded information, such as block size, colour format, single/dual tree partitioning, colour component, slice/picture type.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one or multiple CTUs/CTBs, one or multiple Virtual Pipeline Data Unit (VPDU), a sub-region within a picture/slice/tile/brick. In the following discussion, IntraTMP may be replaced by other coding tools that rely on coded/decoded/reconstructed information within the same region, e.g., palette, intra block copy (IBC).

FIG. 19 illustrates a flowchart of a method 1900 for video processing in accordance with embodiments of the present disclosure. The method 1900 is implemented during a conversion between a video unit of a video and a bitstream of the video.

At block 1910, for a conversion between a video unit of a video and a bitstream of the video, a process is applied to the video unit based on coding information of a non-adjacent neighbor video unit.

At block 1920, the conversion is performed based on the processed video unit. In some embodiments, the conversion may include encoding the video unit into the bitstream. Alternatively, or in addition, the conversion may include decoding the video unit from the bitstream. In this way, it improves coding efficiency and coding performance.

In some embodiments, intra mode coding information of the non-adjacent neighbor video unit is used for at least one of: intra, intra block copy (IBC), or an inter mode coding of the video unit. For example, the intra mode coding information comprises an intra mode index. In some other embodiments, the intra mode coding information comprises one of: an intra tool used flag, an intra tool enabled flag, or an intra on-off flag.

In some embodiments, IBC mode coding information of the non-adjacent neighbor video unit is used for at least one of: intra, intra block copy (IBC), or an inter mode coding of the video unit. For example, the IBC mode coding information comprises a block vector.

In some embodiments, inter mode coding information of the non-adjacent neighbor video unit is used for at least one of: intra, intra block copy (IBC), or an inter mode coding of the video unit. For example, inter mode coding information comprises at least one of: motion vectors, block vectors, reference index, or inter prediction direction.

In some embodiments, the non-adjacent neighbor video unit is a video unit in one of: a current picture, a current subpicture, a current tile, a current slice, a current coding tree unit (CTU) row, a current CTU, or a current virtual pipeline data unit (VPDU). In some other embodiments, the non-adjacent neighbor video unit is a video unit in one of: a reference picture, a reference subpicture, a reference tile, a reference slice, a reference CTU row, a reference CTU, or a reference VPDU.

In some embodiments, a position of the non-adjacent neighbor video unit is restricted according to a rule. For example, the position of the non-adjacent neighbor video unit is restricted to current CTU row and/or collocated CTU row in a reference picture.

In some embodiments, the position of the non-adjacent neighbor video unit is restricted to current VPDU and/or collocated VPDU in a reference picture. In some other embodiments, the position of the non-adjacent neighbor video unit is restricted to current tile and/or collocated tile in a reference picture.

In some embodiments, the position of the non-adjacent neighbor video unit is restricted to current slice and/or collocated slice in a reference picture. In some other embodiments, the position of the non-adjacent neighbor video unit is restricted to current subpicture and/or collocated subpicture in a reference picture. In some further embodiments, the position of the non-adjacent neighbor video unit is restricted to current picture and/or reference pictures.

In some embodiments, the position of the non-adjacent neighbor video unit is restricted to not exceed a decoded region of left M1 CTUs and/or above M2 CTUs and/or right M3 CTUs. Alternatively, or in addition, the position of the non-adjacent neighbor video unit is restricted to not exceed a decoded region of left M1 VPDUs and/or above M2 VPDUs and/or right M3 VPDUs. For example, at least one of: M1, M2, or M3 is constant. In some embodiments, at least one of: M1, M2, or M3 is variable dependent on block width and/or height.

In some embodiments, the position of the non-adjacent neighbor video unit is restricted to not exceed a decoded region of a*cuWidth+b*cuHeight, wherein a and b are parameters, cuWidth represents a width of a coding unit, and cuHeight represents a height of the coding unit. In some embodiments, at least one of: a or b is constant. In some other embodiments, at least one of: a or b is variable dependent on block width and/or height. In some embodiments, the non-adjacent neighbor video unit is a video unit coded prior to a current video unit.

In some embodiments, whether a block is a non-adjacent neighbor video unit of a current video unit is dependent on a position (x0, y0) of the block and a position (x1, y1) of the current video unit, wherein x0, y0, x1, and y1 are numbers. For example, the block is a previous coded video unit.

In some embodiments, x0 is not equal to x1. Alternatively, or in addition, y0 is not equal to y1.

In some embodiments, an absolute value of y0−y1 is larger than or no less than b. Alternatively, or in addition, an absolute value of x0−x1 is larger than or no less than a, a and b are parameters. For example, abs(x0−x1)>a and/or abs(y0−y1)>b. As another example, abs(x0−x1)>=a and/or abs(y0−y1)>=b. In this case, abs represents an absolute value. In some embodiments, a is equal to a value from {0, 1, 2, 3, 4, 5, 6, 7, 8, 16, 24, 32}. Alternatively, or in addition, b is equal to a value from {0, 1, 2, 3, 4, 5, 6, 7, 8, 16, 24, 32}.

In some embodiments, the position is the center of the block. In some other embodiments, the position is a left top corner of the block. In some further embodiments, the position is a right bottom corner of the block.

In some embodiments, whether a utilize of apply the process based on the coding information of the non-adjacent neighbor video unit is at a video unit level is based on a pre-defined rule. In some other embodiments, whether a utilize of apply the process based on the coding information of the non-adjacent neighbor video unit is at a video unit level is based on a syntax element. In some embodiments, non-adjacent neighbor video units are checked after at least one neighbor video unit, if the at least one neighbor video unit is used to predict the current block.

In some embodiments, the coding information of the non-adjacent neighbor video unit is used for an intra prediction mode (IPM) list generation or most probable mode (MPM) list generation of the video unit. For example, the coding information is used for regular intra MPM list generation. In some embodiments, the coding information is used for template-based intra mode derivation (TIMD) MPM list generation or TIMD IPM list generation. In some embodiments, the coding information is used for spatial geometric partitioning mode (SGPM) MPM list generation or SGPM IPM list generation.

In some embodiments, the coding information is used for geometric partitioning mode (GPM) inter-intra MPM list generation or GPM IPM list generation. In some embodiments, the coding information is used for template-based multiple reference line intra prediction (TMRL) MPM list generation or TMRL IPM list generation.

In some embodiments, the coding information is used for IBC fusion MPM list generation or IBC fusion IPM list generation. For example, the IBC fusion comprises IBC combined inter intra prediction (CIIP).

In some embodiments, the coding information is used for geometrical IBC MPM list generation or geometrical IBC IPM list generation. In some embodiments, the mode candidates derived from the non-adjacent neighbor video unit are put after those mode candidates derived from adjacent neighbor video units. In some embodiments, mode candidates derived from the non-adjacent neighbor video unit are put after TIMD candidate or decoder side intra mode derivation (DIMD) candidate. In some embodiments, an MPM/IPM list is primary MPM/IPM list and/or secondary MPM/IPM list.

In some embodiments, the coding information of the non-adjacent neighbor video unit is stored or derived based on a local buffer. For example, the local buffer is a history-based table.

In some embodiments, the local buffer is represented by a look-up-table. For example, the local buffer is represented by a history-based look-up-table.

In some embodiments, one or more local buffers are maintained during a coding process of one of: a current picture, a current subpicture, a current tile, a current tile group, a current CTU, or a current CTU row. In some embodiments, elements in the one or more local buffers are dynamically updated.

In some embodiments, the elements in the look-up-table are updated along with an encoding/decoding of a video unit in one of: the current picture, the current, the current subpicture, the current tile, the current tile group, the current CTU or the current CTU row, and then used for coding of a future video unit in one of: the current picture, the current subpicture, the current tile, the current tile group, the current CTU, the current CTU row, or a current VPDU.

In some embodiments, a table length or a table size is equal to L which is a number. For example, L is pre-defined and equal to a constant. As another example, L is a variable based on at least one of: sequence resolution or block dimensions.

In some embodiments, the local buffer comprises coding information of at least one of: adjacent neighbor video units or non-adjacent neighbor video units. For example, the local buffer comprises coding information of both adjacent neighbor video units and non-adjacent neighbor video units. In some embodiments, the local buffer comprises coding information of non-adjacent neighbor video units. In some other embodiments, the local buffer comprises coding information of adjacent neighbor video units.

In some embodiments, the coding information of one of: an intra mode coded video unit, an IBC mode coded video unit, or inter mode coded video unit is stored in the local buffer. For example, the local buffer is used for one of: intra mode coding, IBC mode coding, or inter mode coding of future video unit.

In some embodiments, the coding information of: an intra mode coded video unit, an IBC mode coded video unit, or inter mode coded video unit is stored in local buffers, separately. In some embodiments, the coding information of an intra mode coded video unit is stored in a local buffer Lᵢₙₜᵣₐ. In some other embodiments, the coding information of an inter mode coded video unit is stored in a local buffer Lᵢₙₜₑᵣ.

In some embodiments, the coding information of an IBC mode coded video unit is stored in a local buffer L_{IBC}. In some embodiments, the coding information of at least one of: the intra mode coded video unit, the IBC mode coded video unit, or the inter mode coded video unit is stored together in a local buffer Lₘᵢₓ.

In some embodiments, a construction or generation of the look-up-table follows a first-in-first-out (FIFO) rule. In some embodiments, for an intra mode candidate to be inserted to the look-up-table, the intra mode candidate is inserted to a first order of the look-up-table.

In some embodiments, a pruning process is applied during inserting a new intra mode candidate to the look-up-table. In some other embodiments, a pruning is based on comparisons of a to-be-inserted candidate and all available elements in the look-up-table.

In some embodiments, a pruning is based on at least one of: intra mode index values or frequency of intra mode indexes. In some embodiments, a pruning is based on comparisons of a to-be-inserted candidate and M elements in the look-up-table, wherein M is an integer number. For example, the M elements are at pre-defined orders in the look-up-table.

In some embodiments, the M elements comprise a first element in the look-up-table. In some other embodiments, the M elements comprise first and second elements in the look-up-table.

In some embodiments, if there are enough coding units coded with a pre-defined intra mode index K, then the intra mode index K is allowed to be inserted to the look-up-table. For example, the number of coding units coded with the pre-defined intra mode index K is not less than a threshold number. In some embodiments, intra mode coding for current video unit is based on coding information stored in the local buffer.

In some embodiments, the coding information of the non-adjacent neighbor video unit is stored or derived based on a buffer, and wherein the buffer is one of: a picture wise buffer, a subpicture wise buffer, a tile wise buffer, a tile group wise buffer, a CTU wise buffer, a CTU row wise buffer, or a VPDU wise buffer. In some embodiments, coding information of video units in at least one of: the current picture, the current subpicture, the current tile group, or the current tile is stored in the buffer. In some embodiments, the coding information in the buffer is used for coding of a future video unit in at least one of: the current picture, the current subpicture, the current tile, the current tile group, the current CTU, the current CTU row, or the current VPDU. In some embodiments, the coding information in the buffer is used for a coding of a future video unit in at least one of: a future picture, a future subpicture, a future tile, a future tile group, a future CTU, a future CTU row, or a future VPDU.

In some embodiments, intra mode coding for current video unit is based on coding information stored in the buffer. In some embodiments, positions of non-adjacent neighbor video units used for current intra mode coding are predefined. In some embodiments, the positions are aligned with non-adjacent inter merge candidates in the current picture and/or reference picture. In some embodiments, the positions are a subset of non-adjacent inter merge candidates in the current picture and/or reference picture.

In some embodiments, intra coding information is stored in M×N granularity, wherein M and N are integer numbers. For example, M=N=4.

In some embodiments, the intra coding information of a block covered by or covering or overlapped with the M×N region is stored to the M×N region. For example, the intra coding information of a first coded/decode block with intra information covered by or covering or overlapped with the M×N region is stored.

In some embodiments, the intra coding information of a last coded/decode block with intra information covered by or covering or overlapped with the M×N region is stored. In some other embodiments, the intra coding information of a coded/decode block with intra information covered by or covering or overlapped a position of the M×N region is stored. For example, the position is one of: top-left, bottom-right, top-right, bottom-left, or a center position of the M×N region. In some embodiments, the intra coding information is stored in luma and chroma components separately.

In some embodiments, a syntax element (SE) is binarized as one of a flag, a fixed length code, an EG(x) code, a unary code, a truncated unary code, or a truncated binary code. In some embodiments, the SE is signed or unsigned.

In some embodiments, the SE is coded with at least one context model. In some other embodiments, the SE is bypass coded.

In some embodiments, the SE is signaled in a conditional way. In some embodiments, the SE is signaled only if a corresponding function is applicable.

In some embodiments, the SE is indicated at one of the followings: sequence level, group of pictures level, picture level, slice level, or tile group level. In some embodiments, the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

In some embodiments, an indication of whether to and/or how to apply the process to the video unit based on the coding information of the non-adjacent neighbor video unit is indicated at one of the followings: sequence level, group of pictures level, picture level, slice level, or tile group level. In some embodiments, an indication of whether to and/or how to apply the process to the video unit based on the coding information of the non-adjacent neighbor video unit is indicated in one of the following: a sequence header, a picture header, a sequence parameter set (SPS), a video parameter set (VPS), a decoding parameter set (DPS), a decoding capability information (DCI), a picture para meter set (PPS), an adaptation parameter sets (APS), a slice header, or a tile group header.

In some embodiments, an indication of whether to and/or how to apply the process to the video unit based on the coding information of the non-adjacent neighbor video unit in one of the following: a prediction block (PB), a transform block (TB), a coding block (CB), a prediction unit (PU), a transform unit (TU), a coding unit (CU), a coding tree block (CTB), a coding tree unit (CTU).

In some embodiments, the method further comprises determining, based on coded information of the video unit, whether and/or how to apply the process to the video unit based on the coding information. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: applying a process to a video unit of the video based on coding information of a non-adjacent neighbor video unit; and generating the bitstream based on the processed video unit.

According to still further embodiments of the present disclosure, a method for storing bitstream of a video is provided. The method comprises: applying a process to a video unit of the video based on coding information of a non-adjacent neighbor video unit; generating the bitstream based on the processed video unit; and storing the bitstream in a non-transitory computer-readable recording medium.

Implementations of the present disclosure can be described in view of the following clauses, the features of which can be combined in any reasonable manner.

Clause 1. A method of video processing, comprising: applying, for a conversion between a video unit of a video and a bitstream of the video, a process to the video unit based on coding information of a non-adjacent neighbor video unit; and performing the conversion based on the processed video unit.

Clause 2. The method of Clause 1, wherein intra mode coding information of the non-adjacent neighbor video unit is used for at least one of: intra, intra block copy (IBC), or an inter mode coding of the video unit.

Clause 3. The method of Clause 2, wherein the intra mode coding information comprises an intra mode index.

Clause 4. The method of Clause 2, wherein the intra mode coding information comprises one of: an intra tool used flag, an intra tool enabled flag, or an intra on-off flag.

Clause 5. The method of Clause 1, wherein IBC mode coding information of the non-adjacent neighbor video unit is used for at least one of: intra, intra block copy (IBC), or an inter mode coding of the video unit.

Clause 6. The method of Clause 5, wherein the IBC mode coding information comprises a block vector.

Clause 7. The method of Clause 1, wherein inter mode coding information of the non-adjacent neighbor video unit is used for at least one of: intra, intra block copy (IBC), or an inter mode coding of the video unit.

Clause 8. The method of Clause 7, wherein inter mode coding information comprises at least one of: motion vectors, block vectors, reference index, or inter prediction direction.

Clause 9. The method of Clause 1, wherein the non-adjacent neighbor video unit is a video unit in one of: a current picture, a current subpicture, a current tile, a current slice, a current coding tree unit (CTU) row, a current CTU, or a current virtual pipeline data unit (VPDU).

Clause 10. The method of Clause 1, wherein the non-adjacent neighbor video unit is a video unit in one of: a reference picture, a reference subpicture, a reference tile, a reference slice, a reference CTU row, a reference CTU, or a reference VPDU.

Clause 11. The method of Clause 1, wherein a position of the non-adjacent neighbor video unit is restricted according to a rule.

Clause 12. The method of Clause 11, wherein the position of the non-adjacent neighbor video unit is restricted to current CTU row and/or collocated CTU row in a reference picture.

Clause 13. The method of Clause 11, wherein the position of the non-adjacent neighbor video unit is restricted to current VPDU and/or collocated VPDU in a reference picture.

Clause 14. The method of Clause 11, wherein the position of the non-adjacent neighbor video unit is restricted to current tile and/or collocated tile in a reference picture.

Clause 15. The method of Clause 11, wherein the position of the non-adjacent neighbor video unit is restricted to current slice and/or collocated slice in a reference picture.

Clause 16. The method of Clause 11, wherein the position of the non-adjacent neighbor video unit is restricted to current subpicture and/or collocated subpicture in a reference picture.

Clause 17. The method of Clause 11, wherein the position of the non-adjacent neighbor video unit is restricted to current picture and/or reference pictures.

Clause 18. The method of Clause 11, wherein the position of the non-adjacent neighbor video unit is restricted to not exceed a decoded region of left M1 CTUs and/or above M2 CTUs and/or right M3 CTUs, and/or the position of the non-adjacent neighbor video unit is restricted to not exceed a decoded region of left M1 VPDUs and/or above M2 VPDUs and/or right M3 VPDUs.

Clause 19. The method of Clause 18, wherein at least one of: M1, M2, or M3 is constant.

Clause 20. The method of Clause 18, wherein at least one of: M1, M2, or M3 is variable dependent on block width and/or height.

Clause 21. The method of Clause 11, wherein the position of the non-adjacent neighbor video unit is restricted to not exceed a decoded region of a*cuWidth+b*cuHeight, wherein a and b are parameters, cu Width represents a width of a coding unit, and cuHeight represents a height of the coding unit.

Clause 22. The method of Clause 21, wherein at least one of: a or b is constant.

Clause 23. The method of Clause 21, wherein at least one of: a or b is variable dependent on block width and/or height.

Clause 24. The method of Clause 11, wherein the non-adjacent neighbor video unit is a video unit coded prior to a current video unit.

Clause 25. The method of Clause 1, wherein whether a block is a non-adjacent neighbor video unit of a current video unit is dependent on a position (x0, y0) of the block and a position (x1, y1) of the current video unit, wherein x0, y0, x1, and y1 are numbers.

Clause 26. The method of Clause 25, wherein the block is a previous coded video unit.

Clause 27. The method of Clause 25, wherein x0 is not equal to x1, and/or wherein y0 is not equal to y1.

Clause 28. The method of Clause 25, wherein an absolute value of y0−y1 is larger than or no less than b, and/or wherein an absolute value of x0−x1 is larger than or no less than a, a and b are parameters.

Clause 29. The method of Clause 28, wherein abs(x0−x1)>a and/or abs(y0−y1)>b, or wherein abs(x0−x1)>=a and/or abs(y0−y1)>=b, and wherein abs represents an absolute value.

Clause 30. The method of Clause 28, wherein a is equal to a value from {0, 1, 2, 3, 4, 5, 6, 7, 8, 16, 24, 32}, and/or wherein b is equal to a value from {0, 1, 2, 3, 4, 5, 6, 7, 8, 16, 24, 32}.

Clause 31. The method of Clause 25, wherein the position is the center of the block.

Clause 32. The method of Clause 25, wherein the position is a left top corner of the block, or wherein the position is a right bottom corner of the block.

Clause 33. The method of Clause 1, wherein whether a utilize of apply the process based on the coding information of the non-adjacent neighbor video unit is at a video unit level is based on a pre-defined rule.

Clause 34. The method of Clause 1, wherein whether a utilize of apply the process based on the coding information of the non-adjacent neighbor video unit is at a video unit level is based on a syntax element.

Clause 35. The method of Clause 1, wherein non-adjacent neighbor video units are checked after at least one neighbor video unit, if the at least one neighbor video unit is used to predict the current block.

Clause 36. The method of any of Clauses 1-35, wherein the coding information of the non-adjacent neighbor video unit is used for an intra prediction mode (IPM) list generation or most probable mode (MPM) list generation of the video unit.

Clause 37. The method of Clause 36, wherein the coding information is used for regular intra MPM list generation.

Clause 38. The method of Clause 36, wherein the coding information is used for template-based intra mode derivation (TIMD) MPM list generation or TIMD IPM list generation.

Clause 39. The method of Clause 36, wherein the coding information is used for spatial geometric partitioning mode (SGPM) MPM list generation or SGPM IPM list generation.

Clause 40. The method of Clause 36, wherein the coding information is used for geometric partitioning mode (GPM) inter-intra MPM list generation or GPM IPM list generation.

Clause 41. The method of Clause 36, wherein the coding information is used for template-based multiple reference line intra prediction (TMRL) MPM list generation or TMRL IPM list generation.

Clause 42. The method of Clause 36, wherein the coding information is used for IBC fusion MPM list generation or IBC fusion IPM list generation.

Clause 43. The method of Clause 42, wherein the IBC fusion comprises IBC combined inter intra prediction (CIIP).

Clause 44. The method of Clause 36, wherein the coding information is used for geometrical IBC MPM list generation or geometrical IBC IPM list generation.

Clause 45. The method of Clause 36, the mode candidates derived from the non-adjacent neighbor video unit are put after those mode candidates derived from adjacent neighbor video units.

Clause 46. The method of Clause 36, wherein mode candidates derived from the non-adjacent neighbor video unit are put after TIMD candidate or decoder side intra mode derivation (DIMD) candidate.

Clause 47. The method of Clause 36, wherein an MPM/IPM list is primary MPM/IPM list and/or secondary MPM/IPM list.

Clause 48. The method of any of Clauses 1-47, wherein the coding information of the non-adjacent neighbor video unit is stored or derived based on a local buffer.

Clause 49. The method of Clause 48, wherein the local buffer is a history-based table.

Clause 50. The method of Clause 48, wherein the local buffer is represented by a look-up-table.

Clause 51. The method of Clause 50, wherein the local buffer is represented by a history-based look-up-table.

Clause 52. The method of Clause 48, wherein one or more local buffers are maintained during a coding process of one of: a current picture, a current subpicture, a current tile, a current tile group, a current CTU, or a current CTU row, and wherein elements in the one or more local buffers are dynamically updated.

Clause 53. The method of Clause 52, wherein the elements in the look-up-table are updated along with an encoding/decoding of a video unit in one of: the current picture, the current, the current subpicture, the current tile, the current tile group, the current CTU or the current CTU row, and then used for coding of a future video unit in one of: the current picture, the current subpicture, the current tile, the current tile group, the current CTU, the current CTU row, or a current VPDU.

Clause 54. The method of Clause 52, wherein a table length or a table size is equal to L which is a number.

Clause 55. The method of Clause 54, wherein L is pre-defined and equal to a constant.

Clause 56. The method of Clause 54, wherein L is a variable based on at least one of: sequence resolution or block dimensions.

Clause 57. The method of Clause 53, wherein the local buffer comprises coding information of at least one of: adjacent neighbor video units or non-adjacent neighbor video units.

Clause 58. The method of Clause 57, wherein the local buffer comprises coding information of both adjacent neighbor video units and non-adjacent neighbor video units.

Clause 59. The method of Clause 57, wherein the local buffer comprises coding information of non-adjacent neighbor video units.

Clause 60. The method of Clause 57, wherein the local buffer comprises coding information of adjacent neighbor video units.

Clause 61. The method of Clause 53, wherein the coding information of one of: an intra mode coded video unit, an IBC mode coded video unit, or inter mode coded video unit is stored in the local buffer.

Clause 62. The method of Clause 61, wherein the local buffer is used for one of: intra mode coding, IBC mode coding, or inter mode coding of future video unit.

Clause 63. The method of Clause 61, wherein the coding information of: an intra mode coded video unit, an IBC mode coded video unit, or inter mode coded video unit is stored in local buffers, separately.

Clause 64. The method of Clause 61, wherein the coding information of an intra mode coded video unit is stored in a local buffer Lᵢₙₜᵣₐ.

Clause 65. The method of Clause 61, wherein the coding information of an inter mode coded video unit is stored in a local buffer Lᵢₙₜₑᵣ.

Clause 66. The method of Clause 61, wherein the coding information of an IBC mode coded video unit is stored in a local buffer L_{IBC}.

Clause 67. The method of Clause 61, wherein the coding information of at least one of: the intra mode coded video unit, the IBC mode coded video unit, or the inter mode coded video unit is stored together in a local buffer Lₘᵢₓ.

Clause 68. The method of Clause 61, wherein a construction or generation of the look-up-table follows a first-in-first-out (FIFO) rule.

Clause 69. The method of Clause 68, wherein for an intra mode candidate to be inserted to the look-up-table, the intra mode candidate is inserted to a first order of the look-up-table.

Clause 70. The method of Clause 61, wherein a pruning process is applied during inserting a new intra mode candidate to the look-up-table.

Clause 71. The method of Clause 61, wherein a pruning is based on comparisons of a to-be-inserted candidate and all available elements in the look-up-table.

Clause 72. The method of Clause 61, wherein a pruning is based on comparisons of a to-be-inserted candidate and M elements in the look-up-table, wherein M is an integer number.

Clause 73. The method of Clause 72, wherein the M elements are at pre-defined orders in the look-up-table.

Clause 74. The method of Clause 72, wherein the M elements comprise a first element in the look-up-table.

Clause 75. The method of Clause 72, wherein the M elements comprise first and second elements in the look-up-table.

Clause 76. The method of Clause 61, wherein a pruning is based on at least one of: intra mode index values or frequency of intra mode indexes.

Clause 77. The method of Clause 61, wherein if there are enough coding units coded with a pre-defined intra mode index K, then the intra mode index K is allowed to be inserted to the look-up-table.

Clause 78. The method of Clause 77, wherein the number of coding units coded with the pre-defined intra mode index K is not less than a threshold number.

Clause 79. The method of Clause 61, wherein intra mode coding for current video unit is based on coding information stored in the local buffer.

Clause 80. The method of any of Clauses 1-79, wherein the coding information of the non-adjacent neighbor video unit is stored or derived based on a buffer, and wherein the buffer is one of: a picture wise buffer, a subpicture wise buffer, a tile wise buffer, a tile group wise buffer, a CTU wise buffer, a CTU row wise buffer, or a VPDU wise buffer.

Clause 81. The method of Clause 80, wherein coding information of video units in at least one of: the current picture, the current subpicture, the current tile group, or the current tile is stored in the buffer.

Clause 82. The method of Clause 81, wherein the coding information in the buffer is used for coding of a future video unit in at least one of: the current picture, the current subpicture, the current tile, the current tile group, the current CTU, the current CTU row, or the current VPDU.

Clause 83. The method of Clause 81, wherein the coding information in the buffer is used for a coding of a future video unit in at least one of: a future picture, a future subpicture, a future tile, a future tile group, a future CTU, a future CTU row, or a future VPDU.

Clause 84. The method of Clause 80, wherein intra mode coding for current video unit is based on coding information stored in the buffer.

Clause 85. The method of Clause 84, wherein positions of non-adjacent neighbor video units used for current intra mode coding are predefined.

Clause 86. The method of Clause 85, wherein the positions are aligned with non-adjacent inter merge candidates in the current picture and/or reference picture.

Clause 87. The method of Clause 85, wherein the positions are a subset of non-adjacent inter merge candidates in the current picture and/or reference picture.

Clause 88. The method of any of Clauses 1-87, wherein intra coding information is stored in M×N granularity, wherein M and N are integer numbers.

Clause 89. The method of Clause 88, wherein M=N=4.

Clause 90. The method of Clause 88, wherein the intra coding information of a block covered by or covering or overlapped with the M×N region is stored to the M×N region.

Clause 91. The method of Clause 90, wherein the intra coding information of a first coded/decode block with intra information covered by or covering or overlapped with the M×N region is stored.

Clause 92. The method of Clause 90, wherein the intra coding information of a last coded/decode block with intra information covered by or covering or overlapped with the M×N region is stored.

Clause 93. The method of Clause 90, wherein the intra coding information of a coded/decode block with intra information covered by or covering or overlapped a position of the M×N region is stored.

Clause 94. The method of Clause 93, wherein the position is one of: top-left, bottom-right, top-right, bottom-left, or a center position of the M×N region.

Clause 95. The method of any of Clauses 1-94, wherein the intra coding information is stored in luma and chroma components separately.

Clause 96. The method of any of Clauses 1-95, wherein a syntax element (SE) is binarized as one of a flag, a fixed length code, an EG(x) code, a unary code, a truncated unary code, or a truncated binary code.

Clause 97. The method of Clause 96, wherein the SE is signed or unsigned.

Clause 98. The method of any of Clauses 1-97, wherein the SE is coded with at least one context model, or wherein the SE is bypass coded.

Clause 99. The method of any of Clauses 1-97, wherein the SE is signaled in a conditional way.

Clause 100. The method of Clause 99, wherein the SE is signaled only if a corresponding function is applicable.

Clause 101. The method of any of Clauses 1-100, wherein the SE is indicated at one of the followings: sequence level, group of pictures level, picture level, slice level, or tile group level.

Clause 102. The method of any of Clauses 1-100, wherein the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

Clause 103. The method of any of Clauses 1-102, wherein an indication of whether to and/or how to apply the process to the video unit based on the coding information of the non-adjacent neighbor video unit is indicated at one of the followings: sequence level, group of pictures level, picture level, slice level, or tile group level.

Clause 104. The method of any of Clauses 1-102, wherein an indication of whether to and/or how to apply the process to the video unit based on the coding information of the non-adjacent neighbor video unit is indicated in one of the following: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

Clause 105. The method of any of Clauses 1-102, wherein an indication of whether to and/or how to apply the process to the video unit based on the coding information of the non-adjacent neighbor video unit in one of the following: a prediction block (PB), a transform block (TB), a coding block (CB), a prediction unit (PU), a transform unit (TU), a coding unit (CU), a coding tree block (CTB), a coding tree unit (CTU).

Clause 106. The method of any of Clauses 1-105, further comprising: determining, based on coded information of the video unit, whether and/or how to apply the process to the video unit based on the coding information of the non-adjacent neighbor video unit, the coded information including at least one of: a block size, a colour format, a single and/or dual tree partitioning, a colour component, a slice type, or a picture type.

Clause 107. The method of any of Clauses 1-106, wherein the conversion includes encoding the video unit into the bitstream.

Clause 108. The method of any of Clauses 1-106, wherein the conversion includes decoding the video unit from the bitstream.

Clause 109. An apparatus for video processing comprising a processor and a non-transitory memory with instructions thereon, wherein the instructions upon execution by the processor, cause the processor to perform a method in accordance with any of Clauses 1-108.

Clause 110. A non-transitory computer-readable storage medium storing instructions that cause a processor to perform a method in accordance with any of Clauses 1-108.

Clause 111. A non-transitory computer-readable recording medium storing a bitstream of a video which is generated by a method performed by an apparatus for video processing, wherein the method comprises: applying a process to a video unit of the video based on coding information of a non-adjacent neighbor video unit; and generating the bitstream based on the processed video unit.

Clause 112. A method for storing a bitstream of a video, comprising: applying a process to a video unit of the video based on coding information of a non-adjacent neighbor video unit; generating the bitstream based on the processed video unit; and storing the bitstream in a non-transitory computer-readable recording medium.

### Example Device

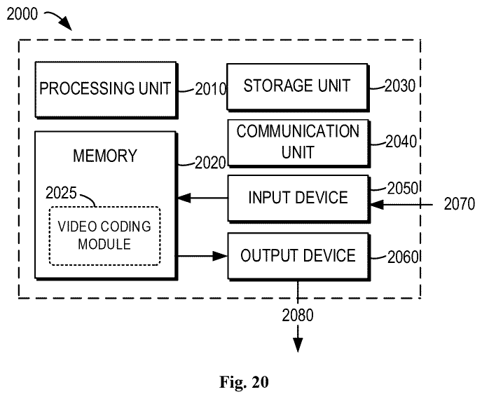

FIG. 20 illustrates a block diagram of a computing device 2000 in which various embodiments of the present disclosure can be implemented. The computing device 2000 may be implemented as or included in the source device 110 (or the video encoder 114 or 200) or the destination device 120 (or the video decoder 124 or 300).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement video encoding/decoding in embodiments of the present disclosure. The memory 2020 may include one or more video coding modules 2025 having one or more program instructions. These modules are accessible and executable by the processing unit 2010 to perform the functionalities of the various embodiments described herein.

In the example embodiments of performing video encoding, the input device 2050 may receive video data as an input 2070 to be encoded. The video data may be processed, for example, by the video coding module 2025, to generate an encoded bitstream. The encoded bitstream may be provided via the output device 2060 as an output 2080.

In the example embodiments of performing video decoding, the input device 2050 may receive an encoded bitstream as the input 2070. The encoded bitstream may be processed, for example, by the video coding module 2025, to generate decoded video data. The decoded video data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, wherein comprising:
applying, for a conversion between a video unit of a video and a bitstream of the video, a process to the video unit based on coding information of a non-adjacent neighbor video unit; and
performing the conversion based on the processed video unit.

2. The method of claim 1, wherein intra mode coding information of the non-adjacent neighbor video unit is used for at least one of: intra, intra block copy (IBC), or an inter mode coding of the video unit, and/or wherein IBC mode coding information of the non-adjacent neighbor video unit is used for at least one of: intra, intra block copy (IBC), or an inter mode coding of the video unit, and/or
wherein inter mode coding information of the non-adjacent neighbor video unit is used for at least one of: intra, intra block copy (IBC), or an inter mode coding of the video unit, and/or
wherein the non-adjacent neighbor video unit is a video unit in one of: a current picture, a current subpicture, a current tile, a current slice, a current coding tree unit (CTU) row, a current CTU, or a current virtual pipeline data unit (VPDU), and/or
wherein the non-adjacent neighbor video unit is a video unit in one of: a reference picture, a reference subpicture, a reference tile, a reference slice, a reference CTU row, a reference CTU, or a reference VPDU, and/or
wherein a position of the non-adjacent neighbor video unit is restricted according to a rule.

3. The method of claim 2, wherein the intra mode coding information comprises an intra mode index, and/or
wherein the intra mode coding information comprises one of: an intra tool used flag, an intra tool enabled flag, or an intra on-off flag, and/or
wherein the IBC mode coding information comprises a block vector, and/or
wherein inter mode coding information comprises at least one of: motion vectors, block vectors, reference index, or inter prediction direction, and/or
wherein the position of the non-adjacent neighbor video unit is restricted to current CTU row and/or collocated CTU row in a reference picture, and/or
wherein the position of the non-adjacent neighbor video unit is restricted to current VPDU and/or collocated VPDU in a reference picture, and/or
wherein the position of the non-adjacent neighbor video unit is restricted to current tile and/or collocated tile in a reference picture, and/or
wherein the position of the non-adjacent neighbor video unit is restricted to current slice and/or collocated slice in a reference picture, and/or
wherein the position of the non-adjacent neighbor video unit is restricted to current subpicture and/or collocated subpicture in a reference picture, and/or
wherein the position of the non-adjacent neighbor video unit is restricted to current picture and/or reference pictures, and/or
wherein the position of the non-adjacent neighbor video unit is restricted to not exceed a decoded region of left M1 CTUs and/or above M2 CTUs and/or right M3 CTUs, and/or
the position of the non-adjacent neighbor video unit is restricted to not exceed a decoded region of left M1 VPDUs and/or above M2 VPDUs and/or right M3 VPDUs, and/or
wherein the position of the non-adjacent neighbor video unit is restricted to not exceed a decoded region of a*cuWidth+b*cuHeight, wherein a and b are parameters, cuWidth represents a width of a coding unit, and cuHeight represents a height of the coding unit, and/or
wherein the non-adjacent neighbor video unit is a video unit coded prior to a current video unit.

4. The method of claim 1, wherein whether a block is a non-adjacent neighbor video unit of a current video unit is dependent on a position (x0, y0) of the block and a position (x1, y1) of the current video unit, wherein x0, y0, x1, and y1 are numbers, and/or
wherein whether a utilize of apply the process based on the coding information of the non-adjacent neighbor video unit is at a video unit level is based on a pre-defined rule, and/or
wherein whether a utilize of apply the process based on the coding information of the non-adjacent neighbor video unit is at a video unit level is based on a syntax element, and/or
wherein non-adjacent neighbor video units are checked after at least one neighbor video unit, if the at least one neighbor video unit is used to predict the current block, and/or
wherein the coding information of the non-adjacent neighbor video unit is used for an intra prediction mode (IPM) list generation or most probable mode (MPM) list generation of the video unit.

5. The method of claim 4, wherein the block is a previous coded video unit, and/or
wherein x0 is not equal to x1, and/or y0 is not equal to y1, and/or
wherein an absolute value of y0−y1 is larger than or no less than b, and/or
wherein an absolute value of x0−x1 is larger than or no less than a, a and b are parameters, and/or wherein the position is the center of the block, and/or
wherein the position is a left top corner of the block, or the position is a right bottom corner of the block, and/or
wherein the coding information is used for regular intra MPM list generation, and/or
wherein the coding information is used for template-based intra mode derivation (TIMD) MPM list generation or TIMD IPM list generation, and/or
wherein the coding information is used for spatial geometric partitioning mode (SGPM) MPM list generation or SGPM IPM list generation, and/or
wherein the coding information is used for geometric partitioning mode (GPM) inter-intra MPM list generation or GPM IPM list generation, and/or
wherein the coding information is used for template-based multiple reference line intra prediction (TMRL) MPM list generation or TMRL IPM list generation, and/or
wherein the coding information is used for IBC fusion MPM list generation or IBC fusion IPM list generation, and/or
wherein the coding information is used for geometrical IBC MPM list generation or geometrical IBC IPM list generation, and/or
wherein the mode candidates derived from the non-adjacent neighbor video unit are put after those mode candidates derived from adjacent neighbor video units, and/or
wherein mode candidates derived from the non-adjacent neighbor video unit are put after TIMD candidate or decoder side intra mode derivation (DIMD) candidate, and/or
wherein an MPM/IPM list is primary MPM/IPM list and/or secondary MPM/IPM list.

6. The method of claim 1, wherein the coding information of the non-adjacent neighbor video unit is stored or derived based on a local buffer.

7. The method of claim 6, wherein the local buffer is a history-based table, and/or
wherein the local buffer is represented by a look-up-table, and/or
wherein one or more local buffers are maintained during a coding process of one of: a current picture, a current subpicture, a current tile, a current tile group, a current CTU, or a current CTU row, and
wherein elements in the one or more local buffers are dynamically updated.

8. The method of claim 7, wherein the elements in the look-up-table are updated along with an encoding/decoding of a video unit in one of: the current picture, the current, the current subpicture, the current tile, the current tile group, the current CTU or the current CTU row, and then used for coding of a future video unit in one of: the current picture, the current subpicture, the current tile, the current tile group, the current CTU, the current CTU row, or a current VPDU, and/or
wherein a table length or a table size is equal to L which is a number.

9. The method of claim 8, wherein the local buffer comprises coding information of at least one of:
adjacent neighbor video units or non-adjacent neighbor video units, and/or
wherein the coding information of one of: an intra mode coded video unit, an IBC mode coded video unit, or inter mode coded video unit is stored in the local buffer.

10. The method of claim 9, wherein the local buffer is used for one of: intra mode coding, IBC mode coding, or inter mode coding of future video unit, and/or
wherein the coding information of: an intra mode coded video unit, an IBC mode coded video unit, or inter mode coded video unit is stored in local buffers, separately, and/or
wherein the coding information of an intra mode coded video unit is stored in a local buffer Lᵢₙₜᵣₐ, and/or
wherein the coding information of an inter mode coded video unit is stored in a local buffer Lᵢₙₜₑᵣ, and/or
wherein the coding information of an IBC mode coded video unit is stored in a local buffer L_{IBC}, and/or
wherein the coding information of at least one of: the intra mode coded video unit, the IBC mode coded video unit, or the inter mode coded video unit is stored together in a local buffer Lₘᵢₓ, and/or
wherein a construction or generation of the look-up-table follows a first-in-first-out (FIFO) rule, and/or
wherein a pruning process is applied during inserting a new intra mode candidate to the look-up-table, and/or
wherein a pruning is based on comparisons of a to-be-inserted candidate and all available elements in the look-up-table, and/or
wherein a pruning is based on comparisons of a to-be-inserted candidate and M elements in the look-up-table, wherein M is an integer number, and/or
wherein a pruning is based on at least one of: intra mode index values or frequency of intra mode indexes, and/or
wherein if there are enough coding units coded with a pre-defined intra mode index K, then the intra mode index K is allowed to be inserted to the look-up-table, and/or
wherein intra mode coding for current video unit is based on coding information stored in the local buffer.

11. The method of claim 1, wherein the coding information of the non-adjacent neighbor video unit is stored or derived based on a buffer, and wherein the buffer is one of: a picture wise buffer, a subpicture wise buffer, a tile wise buffer, a tile group wise buffer, a CTU wise buffer, a CTU row wise buffer, or a VPDU wise buffer, and/or
wherein intra coding information is stored in M×N granularity, wherein M and N are integer numbers, and/or
wherein the intra coding information is stored in luma and chroma components separately.

12. The method of claim 11, wherein coding information of video units in at least one of: the current picture, the current subpicture, the current tile group, or the current tile is stored in the buffer, and/or
wherein intra mode coding for current video unit is based on coding information stored in the buffer.

13. The method of claim 12, wherein the coding information in the buffer is used for coding of a future video unit in at least one of: the current picture, the current subpicture, the current tile, the current tile group, the current CTU, the current CTU row, or the current VPDU, and/or
wherein the coding information in the buffer is used for a coding of a future video unit in at least one of: a future picture, a future subpicture, a future tile, a future tile group, a future CTU, a future CTU row, or a future VPDU, and/or
wherein positions of non-adjacent neighbor video units used for current intra mode coding are predefined.

14. The method of claim 11, wherein M=N=4, and/or
wherein the intra coding information of a block covered by or covering or overlapped with the M×N region is stored to the M×N region.

15. The method of claim 14, wherein the intra coding information of a first coded/decode block with intra information covered by or covering or overlapped with the M×N region is stored, and/or
wherein the intra coding information of a last coded/decode block with intra information covered by or covering or overlapped with the M×N region is stored, and/or
wherein the intra coding information of a coded/decode block with intra information covered by or covering or overlapped a position of the M×N region is stored.

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to perform a method comprising:
applying, for a conversion between a video unit of a video and a bitstream of the video, a process to the video unit based on coding information of a non-adjacent neighbor video unit; and
performing the conversion based on the processed video unit.

19. A non-transitory computer-readable storage medium storing instructions that cause a processor to perform a method comprising:
applying, for a conversion between a video unit of a video and a bitstream of the video, a process to the video unit based on coding information of a non-adjacent neighbor video unit; and
performing the conversion based on the processed video unit.

20. A non-transitory computer-readable recording medium storing a bitstream of a video which is generated by a method performed by an apparatus for video processing, wherein the method comprises:
applying a process to a video unit of the video based on coding information of a non-adjacent neighbor video unit; and
generating the bitstream based on the processed video unit.
